(19) United States
(12) Patent Application Publication
(10) Pub. No.: US 2016/0017109 A1
(43) Pub. Date: Jan. 21, 2016

(54) LATEX COMPOSITION

(71) Applicant: SOBELTEC, Ronse (BE)

(72) Inventor: Arnaud R. W. BOSTYN, Bruxelles (BE)

(73) Assignee: SOBELTEC, Ronse (BE)

(21) Appl. No.: 14/426,039

(22) PCT Filed: Jul. 17, 2013
(86) PCT No.: PCT/EP2013/065105

§ 371 Date: Jul. 28, 2015

(30) Foreign Application Priority Data
Jul. 18, 2012 (BE) 2012/0498
Jul. 18, 2012 (EP) 12176808

(51) Int. Cl. C08J 9/14; B29C 71/04; B29C 44/02

(52) U.S. Cl. CPC C08J 9/142; B29C 44/02; B29C 71/04; C08J 2309/08; C08J 2383/06; B29K 2009/06

(57) ABSTRACT

The present invention relates to a latex composition comprising:
a) at least one compound of latex containing less than 55% of styrene,
b) a heat-sensitive gelling agent selected from the group of polyether-polysiloxanes,
c) a foaming agent, and
d) at least one vulcanizing agent.

The present invention relates to a latex composition comprising:

a) at least one latex compound containing less than 55% of styrene,
b) a gelling agent sensitive to heat selected from the group of polyether-polysiloxanes,
c) a foaming agent, and
d) at least one vulcanizing agent.

Such a latex composition is used for example to form solid slip-resistant protrusions on backing of carpets or rugs, mats and the like. In this particular application, droplets of predetermined size of the aforesaid latex composition having a high density usually exceeding 700 g/l are applied onto these tufted or needled carpets and then thermally gelled. The gelation of the droplets forms substantially solid protrusions (pellets) that have a high coefficient of friction with the ground on which they are contacted and thus give anti-slip properties to the mat. These protrusions must keep their shape and not collapse when pressure is exerted thereon, for example when walking on the carpet. This is why, for this particular application, the latex composition has to be foamed a little to exhibit this high density above 700 g/l or even of the order of 750 g/l. The foaming agent currently used for this purpose is typically an anionic foaming agent selected from those well known in the prior art, such as an anionic foaming agent selected from the group of alkyl sulfonates, alpha olefin sulfonates, alkyl sulfates, alkyl ether sulfates or further salts of fatty acids.

Unfortunately, such a composition, comprising a gelling agent selected from the group of polyether-polysiloxanes and an anionic foaming agent (such as those used currently) does not provide a stable and gellable low density latex composition after significant foaming, for example to form homogeneous and continuous backings of conventional carpets (e.g. indoor), latex mattresses, wall supports or woven or nonwoven carpet undersides. Indeed, the manufacture of carpet backing, rugs or mats requires the application of a uniform layer of latex on the face of the carpet, rug or mat that will be in contact with the ground. This layer, flat and uniform in the wet state, applied by an industrial applicator like a doctor blade or roller, should be able to be sufficiently foamed before gelation in order to obtain, after drying, slip-resistant, resilient, abrasion and moisture resistant characteristics. Further, the density of this type of composition must be relatively low so as not to unduly burden the carpet and give the foamed layer the necessary resiliency for comfort when trampled. Indeed, a composition as that used for forming solid anti-slip protrusions does not allow impacts to be damped since a density of about 700 g/l of said latex composition does not impart damping capacity.

Within the framework of mattress manufacturing, the product density should also not be very high otherwise the thereby produced mattress would neither be manipulated because of his weight, nor comfortable because of its low resiliency. Further, for mattresses, the latex composition must have the capacities to spread when it is poured into molds in order to form a uniform thickness and a planar surface on both sides of the mattress. These latex compositions are now heavily foamed to attain densities of less than 400 g/l.

Within the framework of the manufacturing of wall supports, gelation is required for enabling stamping, before vulcanization, which provides a decorative appearance.

Today, the latex compositions used in the manufacture of carpet backings use gelling agents such as ammonium acetate, ammonium sulfate, ammonium chloride and alkaline metal fluorosilicates, such as sodium fluorosilicate (FSS). Before gelling, foaming of these latex-based compositions is always ensured by adding an anionic foaming agent, for example a surfactant based on potassium oleate (see, for example, U.S. Pat. No. 4,214,053).

Regarding the latex compositions used in the manufacture of mattresses, two major processes are currently applied, namely the Talalay process and the Dunlop process. For the first, the gelling agent used is carbon dioxide, while for the second, the gelling agent is sodium fluorosilicate (FSS). However, such compositions comprising ammonium or alkaline metal fluorosilicate salts as gelling agents are noxious to human health. Indeed, inhalation of volatile compounds emitted at the start of these gelling agents severely irritates the airways. For example, during prolonged exposures, ammonium acetate releases ammonia and acetic acid which, in addition to their unpleasant odor, irritate mucosas and the upper respiratory tract while sodium fluorosilicate (FSS) may cause bronchopneumonia, pulmonary edema, reduction of the lung function or even heart and nerve problems (Clayton, G D and Clayton, F E, Eds., Patty's Industrial Hygiene and Toxicology, 3rd ed., Vol. IIA, B, C, John Wiley and Sons, New York, 1981). Further, with regard to FSS, toxic products such as hydrogen fluoride, silicon oxides and irritating gases, are released on heating, which is the case during the steps of gelling of the latex-based composition, while also endangering workers of the carpet or mattress production line.

Latex compositions are also known from documents FR 2 298 433, U.S. Pat. No. 3,922,419, FR 2 479 288 and GB 1,214,940. These latex compositions are essentially intended for applying fat and massive coatings and comprise an emulsifier such as for example stearyl isocyanate or Emulvin W which slow down the coagulation of the composition up to a certain temperature. These latex compositions known from the state of the art are therefore not foamed with a foaming agent and exclusively give rise to massive products. Moreover, the solvent used in document U.S. Pat. No. 3,922,419 is a hydrocarbon (toluene) which is insoluble in water and which thus opposes formation of a foam (air bubbles).

The present invention therefore aims to overcome the disadvantages of the prior art by providing a latex composition both free of toxic gelling agents and which is gellable after significant foaming necessary for obtaining a low density of the latex composition for the manufacture of carpet backings and the manufacture of mattresses.

In the sense of the present invention, by the terms of <<stable latex composition>>, is meant a foamed latex composition having a density of less than 450 g/l, preferably less than 350 g/l, the foam of which does not increase in density due to destabilization, for example due to the presence of an antifoam agent in the latex and/or the wrong selection of foaming agents having a stabilizing nature. Moreover, a stable latex composition of the present invention has a foam which does not set in the bulk and does not coagulate at room temperature, that is to say below temperatures of about 40° C.

In the sense of the present invention, by the terms of <<gellable latex composition>>, is meant a foamed latex composition having a density of less than 450 g/l, preferably less than 350 g/l, or an unfoamed latex composition which sets in the bulk and solidifies in less than 10 seconds, during its application, upon contact with a heat source such as infrared lamp, halogen lamp, or hot air according to the following test:

application onto a substrate and over a height of 2 mm of an amount between 2 and 7 g of a foamed or not foamed latex composition to a density of less than 450 g/l,

heating said latex composition applied on said support by using an infrared lamp with a power of 250 watts placed at a height of 5 cm relative to the support, during a maximum time of 15 seconds.

At the end of this heating operation, in order that the latex composition be considered as a gellable latex composition in the sense of the present invention, the gelation (coagulation) of said latex composition must be total, that is to say that the aforesaid heating operation should allow a solid non-liquid mass of said latex composition to be obtained.

Furthermore, the fact that a foamed latex can be gelled first allows the foam to remain stable in thin layers such as those of carpets, but especially in the layers of more than 5 mm such as those of mattresses and then allows embossing with a roller, generating a design in the foam.

To this end, a composition as indicated at the beginning is provided according to the invention, characterized in that said foaming agent is a non-ionic foaming agent and in that said latex composition has, in the foamed and gelled state, a density of less than 450 g/l, preferably less than 350 g/l.

It became apparent, surprisingly, that the non-gelation of the low density latex foam was due to the fact that the gelling agents selected from the group of polyether-polysiloxanes were not compatible with the ionic foaming agents for latex compositions having a density less than 450 g/l, preferably less than 350 g/l after foaming.

The gelling agent selected from the group of polyether-polysiloxanes and already used for forming protrusions on the back of anti-slip carpets nevertheless has the advantage of being a non-toxic gelling agent with strongly reduced emission of volatile compounds noxious to human health, but unfortunately it does not allow gelation for obtaining a stable foam at densities below 450 g/l.

Within the scope of the present invention, it was observed that this impossibility to gel, against all expectations, was due to the mere presence of anionic foaming agents currently used. This is all the more surprising that in the latex compositions of higher density, the foaming agent is anionic and of a type similar to those commonly used for applications with conventional low-density latex gelling agents such as ammonium acetate, ammonium sulfate, ammonium chloride and alkaline metal fluorosilicates. Indeed, the commonly used foaming agents are anionic stabilizers by the presence of negative charges which are detrimental to the setting of the coagulant. It turned out that the coagulants or the gelling agents selected within the scope of the present invention have temperature-dependent coagulation and that in the presence of currently used anionic foaming agents, this coagulation is slowed down in the latex, which thus prevents gelation.

According to the present invention, the selected foaming agents are non-ionic and act as anticoagulant. In this way, they stabilize the foamed low density composition and prevent coagulation at the foaming temperature (between 1 and 40° C.). Once the foamed latex composition is subjected to the coagulation temperature (between 45 and 240° C.), the foaming agent no longer plays the role of an anticoagulant since the coagulant sensitive to heat (heat sensitive) acts and induces an increase in the viscosity of the latex composition such that said latex composition is gelled in a stable and durable way. With this, it is also possible to obtain a ready-to-use mixture containing the foaming agent, the gelling agent, a vulcanizing agent and the storage (between 5 and 40° C.) and transport stable latex compound. Very advantageously, the presence of the gelling agent in the latex advantageously allows the product to be applied without any risk of premature gelation during foaming and spreading of the product unlike current systems which do require immediate use of the product after injection of the coagulant during foaming, making it inevitable for systematic cleaning of pipes and tools during a machine shutdown.

Equally advantageously, according to the present invention, said latex compound containing less than 55% of styrene is selected from the group consisting of synthetic latices or synthetic latices mixed with natural latices. Indeed, latices of any rubbery polymer may be used for applying the present invention. Thus, natural rubbers and synthetic rubbers such as rubbery diene homopolymers, are concerned, especially butadiene and isoprene homopolymers and rubbery copolymers of dienes with butadiene or isoprene or with copolymerizable ethylenically unsaturated monomers (by example, vinyl halides, styrenes and unsaturated acids such as acrylic acid and its amides, nitriles and esters such as acrylamide, acrylonitrile and methyl acrylate). Are also concerned mixtures of these latices with resin polymer latices of the aforementioned monomers, like for example, polystyrene and copolymers of butadiene and styrene (styrene-butadiene or SBR copolymers), including those modified by carboxy groups (xSBR), etc.

In most latex compositions, an addition of natural latex is mandatory for obtaining a proper gelation, which greatly increases production costs. In the composition of the invention, it is possible to do without such an addition of natural latex.

Preferably, said foaming agent is a non-ionic agent selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof.

These non-ionic foaming agents advantageously give the possibility, according to the present invention, of obtaining a stable latex composition of low density of less than 450 g/l, preferably less than 350 g/l, when in use. These foaming agents are such that the length of the chain is large enough to allow foaming to a density as low as 450 g/l, or even as low as 350 g/l, while being sufficiently small not to prevent gelation without perturbing the stability of the foam.

Indeed, in addition to depending the charges present, gelation also depends on the mother chain length of the foaming agent and on that of the branches. For example, the greater the degree of ethoxylation of the foaming agent is important, the more it is hydrophilic, the side chains being longer.

Preferably, the HLB value (hydrophilic/lipophilic balance) of the foaming agent is between 3 and 8, preferably between 5 and 8.

In the sense of the present invention by the term “HLB” is meant an empirical expression that expresses the empirical hydrophilic and hydrophobic (or lipophilic) relationship of a surfactant (foaming agent). The hydrophilic/hydrophobic balance (HLB) of a surfactant expresses properties of the relevant surfactant. A surfactant will therefore have a greater affinity for water if its HLB is high (hydrophilic nature) and conversely, a surfactant will have lower affinity for water (hydrophobic or lipophilic nature) when its HLB value will be low.

Within the scope of the present invention, it has been shown that such a HLB value comprised between 3 and 8 of the foaming agent corresponds to a foaming agent for which the length of the mother chain and the length of the branches are adequate so that foaming is not too small. A foaming agent having a too large chain length is a highly foaming agent but slows down gelation by breaking the coagulant. On the other hand, a foaming agent having a too short chain length foams with difficulty and interacts less with the coagulant, and so less perturbs gelation. This is why a foaming agent having a suitable chain length is used, which corresponds, as it was shown within the scope of the present invention, to a foaming agent with an HLB value comprised between 3 and 8, preferably between 5 and 8.

Within the scope of the present invention, it was shown that a non-ionic foaming agent, selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof, has a optimal chain length (neither too long nor too short) in order to allow foaming to a density of 450 g/l or to a density of 350 g/l, without preventing gelation and without affecting the stability of the foam.

Preferably, the latex composition according to the invention comprises at least one vulcanizing agent/accelerator selected from the group consisting of oxides, mercaptos, sulfenamides, thiurams, thiocarbamates, amines, thiophosphates, thioureas, thiazoles, guanidines, for example zinc bis-dibutyldithiocarbamate (ZDBC), zinc diethyldithiocarbamate (ZDEC), zinc dimethyldithiocarbamate (ZDMC), zinc or sodium 2-mercaptobenzothiazole (MBT or NaMBT), 2,2′-dithiobenzothiazole disulfide (MBTS), N-cyclohexylbenzothiazole 2-sulfenamide (CBS), N-tert-butylbenzothiazole 2-sulfenamide (TBBS), bis-(triethoxysilylpropyl)tetrasulfide (TESPT), tetraethylthiuram disulfide, tetramethylthiuram disulfide (TMTD), tetramethylthiuram monosulfide (TMTM), tetramethylthiuram polysulfide (TMTP), dipentamethylene thiuram hexasulfide (DPTH), dimethyldithiocarbamate (DMTC), N,N′-ethylene-thiourea (ETU), 2-(morpholinothio)benzothiazole (MBS), sulfur (S), N,N′-diphenylguanidine, N,N′-di-o-tolylguanidine, oxides of magnesium (MgO), zinc (ZnO), calcium (CaO), barium (BaO), copper (CuO), cerium (CeO), stearic acid (SA), zinc stearate, zinc 2-ethylhexanoate (ZEH), zinc monoglycerolate (Zn-m-glyc), zinc sulfide (ZnS), dibutylamine (DBA), diphenylguanidine (DPG), and mixtures thereof.

These vulcanizing/accelerator agents advantageously allow the formation of bridges between the macromolecules so that the final material has some predetermined elasticity and resilience, the formulae and mechanism connections of which are known and published by Geert Heideman (Reduced Zinc Oxide Levels in Sulfur Vulcanization of Rubber Compounds: Mechanistic Aspects of the Role of Activators and Multifunctional Additives, ISBN 9036520819, 9789036520812).

Advantageously, the latex composition according to the invention also includes a mineral filler selected from the group consisting of calcium carbonate, magnesium carbonate, silica, titanium dioxide, potassium titanate, glass fibers, talcum, carbon black, feldspar, clays such as kaolin and alkaline aluminosilicate clay, alumina silicate, iron silicate, alumina and magnesia trihydrates, calcium hydroxide and mixtures thereof. The fillers are dispersed in said latex composition, notably for lowering the production cost, adding weight to the carpet, reducing the drying time and reducing the tackiness of the film.

Equally advantageously, the latex composition according to the present invention further comprises a thickener selected from the group consisting of thickeners based on polyacrylate such as polyvinylpyrrolidone, polyvinyl alcohol, polyacrylates and their salts, based on polyurethane, polysaccharide cellulose and its derivatives such as carboxymethylcellulose, hydroxyethyl(or methyl)cellulose, bentonites, natural gums such as those of xanthan, agar, acacia, guar gum, fumed silica and mixtures thereof.

Said thickener is intended to increase the viscosity of said latex composition in order to achieve a predetermined viscosity comprised between 0.5 and 10 Pa·s, preferably a viscosity from 1.4 to 1.8 Pa·s.

Other embodiments of a latex composition according to the invention are indicated in the appended claims.

The invention also relates to products such as combined compositions for simultaneous, separate or staggered in time in order to prepare a foamed and gelled latex having a density of less than 450 g/l, preferably less than 350 g/l, comprising:

a) a first product comprising a gelling agent selected from the group of polyether-polysiloxanes,

b) a second product comprising a vulcanizing agent selected from the group consisting of oxides, mercaptos, sulfenamides, thiurams, thiocarbamates, amines, thiophosphates, thioureas, thiazoles, guanidines, for example zinc bis-dibutyldithiocarbamate (ZDBC), zinc diethyldithiocarbamate (ZDEC), zinc dimethyldithiocarbamate (ZDMC), zinc or sodium 2-mercaptobenzothiazole (MBT or NaMBT), 2,2′-dithiobenzothiazole disulfide (MBTS), N-cyclohexylbenzothiazole 2-sulfenamide (CBS), N-tert-butylbenzothiazole 2-sulfenamide (TBBS), bis-(triethoxysilylpropyl)tetrasulfide (TESPT), tetraethylthiuram disulfide, tetramethylthiuram disulfide (TMTD), tetramethylthiuram monosulfide (TMTM), tetramethylthiuram polysulfide (TMTP), dipentamethylene thiuram hexasulfide (DPTH), dimethyldithiocarbamate (DMTC), N,N′-ethylene thiourea (ETU), 2-(morpholinothio)benzothiazole (MBS), sulfur (S), N,N′-diphenylguanidine, N,N′-di-o-tolylguanidine, oxides of magnesium (MgO), zinc (ZnO), calcium (CaO), barium (BaO), copper (CuO), cerium (CeO), stearic acid (SA), zinc stearate, zinc 2-ethylhexanoate (ZEH), zinc monoglycerolate (Zn-m-glyc), zinc sulfide (ZnS), dibutylamine (DBA), diphenylguanidine (DPG), and mixtures thereof,

c) a third product comprising a foaming agent selected from the non-ionic foaming agents group consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof.

d) a fourth product comprising a latex compound selected from the group of natural latices and synthetic latices and mixtures thereof.

Proposing several separate products rather than a mixture comprising all products simultaneously is particularly advantageous in particular for marketing premixes to be added to a latex compound or to a latex composition as described above and ready to be gelled by heat treatment, subsequently to the mixing. Indeed, the user may keep the different products independently of each other for several months without the latter being altered and deteriorating, which would not be the case if the various products were mixed and reacted together when stored at room temperature. This is particularly advantageous and indicated during storage under conditions of relatively high temperatures, for example in tropical countries where the composition might (pre-)coagulate by itself if the coagulant (gelling agent) was pre-mixed with the latex and possibly with the other aforesaid products before storage.

Advantageously, the products as combined compositions are mixed to form premixes of such combined compositions, such premixes comprising said first and second products and/or said first, second and third products and/or said third and fourth products and/or said second and fourth products.

A premix comprising a gelling agent (first product) and a vulcanizing agent (second product) has the advantage of long shelf life without the products deteriorating or reacting with each other.

Identically, a premix comprising a gelling agent (first product) and a foaming agent (third product) is a mixture of products which will remain stable and will not form derivatives by reactions with each other.

A pre-mix comprising a foaming agent (third product) and a latex compound (fourth product) has the advantage of forming a foamed latex that can be directly associated with the other components during the manufacturing process of a latex composition.

Equally advantageous, a premix comprising a vulcanizing agent (second product) and a latex compound (fourth product) is a mixture of products that will remain stable and will not form derivatives by reactions with each other.

Proposing premixes is of some interest since the user may directly use mixtures whose constituents have previously been metered in the right proportions. Furthermore, initially working with premixes prevents the user from himself/herself having to carry out the mixing of the products, minimizing errors during the formation of mixtures by weighing the individual constituents and that saves some time in the manufacture of latex compositions.

Other embodiments of a latex composition according to the invention are indicated in the appended claims.

The invention also relates to a process for producing a latex composition comprising the following steps:

a) supplying a latex compound selected from the group of natural latices and synthetic latices and mixtures thereof in a mixing vessel,

b) supplying a vulcanizing agent selected from the group of vulcanizing agents consisting of oxides, mercaptos, sulfenamides, thiurams, thiocarbamates, amines, thiophosphates, thioureas, thiazoles, guanidines, for example zinc bis-dibutyldithiocarbamate (ZDBC), zinc diethyldithiocarbamate (ZDEC), zinc dimethyldithiocarbamate (ZDMC), zinc or sodium 2-mercaptobenzothiazole (MBT or NaMBT), 2,2′-dithiobenzothiazole disulfide (MBTS), N-cyclohexylbenzothiazole 2-sulfenamide (CBS), N-tert-butylbenzothiazole 2-sulfenamide (TBBS), bis-(triethoxysilylpropyl)tetrasulfide (TESPT), tetraethylthiuram disulfide, tetramethylthiuram disulfide (TMTD), tetramethylthiuram monosulfide (TMTM), tetramethylthiuram polysulfide (TMTP), dipentamethylene thiuram hexasulfide (DPTH), dimethyldithiocarbamate (DMTC), N,N′-ethylene thiourea (ETU), 2-(morpholinothio)benzothiazole (MBS), sulfur (S), N,N′-diphenylguanidine, N,N′-di-o-tolylguanidine, oxides of magnesium (MgO), zinc (ZnO), calcium (CaO), barium (BaO), copper (CuO), cerium (CeO), stearic acid (SA), zinc stearate, zinc 2-ethylhexanoate (ZEH), zinc monoglycerolate (Zn-m-glyc), zinc sulfide (ZnS), dibutylamine (DBA), diphenylguanidine (DPG), and mixtures thereof.

c) adding a vulcanizing agent in said mixing vessel,

d) supplying a non-ionic foaming agent selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof,

e) adding said non-ionic foaming agent in said mixing vessel to form a gellable foamed latex,

f) supplying a gelling agent selected from the group of polyether-polysiloxanes,

g) adding said gelling agent in said mixing vessel

h) supplying and adding a filler selected from the groups of fillers consisting of calcium carbonate, magnesium carbonate, silica, titanium dioxide, potassium titanate, glass fibers, talcum, carbon black, feldspar, clays such as kaolin and alkaline alumino-silicate clay, alumina silicate, iron silicate, alumina and magnesia trihydrates, calcium hydroxide and mixtures thereof.

i) supplying and adding a thickener selected from the group consisting of thickeners based on polyacrylate such as polyvinylpyrrolidone, polyvinyl alcohol, polyacrylates and their salts, based on polyurethane, polysaccharide cellulose and its derivatives such as carboxymethylcellulose, hydroxyethyl(or methyl)cellulose, bentonites, natural gums such as those of xanthan, agar, acacia, guar gum, fumed silica and mixtures thereof.

j) applying said foamed gellable latex on a support or into a mold,

k) gelling said gellable foamed latex applied to a substrate or in a mold.

Advantageously, according to the invention, the addition of said non-ionic foaming agent is carried out in said vessel containing said compound of latex or in said supply of said gelling agent.

Preferably, according to the invention, the addition of said vulcanizing agent is provided in said vessel containing said latex compound or in said supply of said gelling agent.

These two alternatives advantageously give the possibility of carrying out the various additions at different times, thereby modulating the manufacturing process of said latex composition but also modulating the layout of facilities required for manufacturing said latex composition.

Preferably, according to the manufacturing method of the present invention, said application of said stable foamed and gellable latex, is carried out on a face opposite to a visible face of a carpet.

Preferably, according to the method of the present invention, said gelling of said stable foamed and gelled latex applied to a substrate or in a mold is performed by applying rays characterized by a wavelength in the infrared range. This shifting to infrared provides proper, controlled and faster gelation. The advantage of the use of an infrared (IR) radiation is the deep penetration of the radiation insulation, in the bulk, allowing gelling of the homogeneous foamed layer of said latex composition. Thin layers may be gelled by passing them through a simple oven while for layers thicker than 3 mm, IR is imperative.

Advantageously, the method of the present invention further comprises a step of stamping a pattern on said foamed latex and gel. This step allows the formation of drawings in the gelled layer of latex, these drawings forming recesses that are generally useful for increasing the surface area thereby improving the adhesive or anti-slip properties.

Other embodiments of the manufacturing process of a latex composition according to the invention are indicated in the appended claims.

The invention also relates to the use of the latex composition for manufacturing preferably uniform carpet backings and mattresses.

The invention also relates to the use of a non-ionic foaming agent selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof, for gelling latex compositions having a density of less than 450 g/l, preferably less than 350 g/l, in the foamed and gelled state.

The invention also relates to the use of a non-ionic foaming agent selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof, for manufacturing carpet backings and mattresses.

Other forms of use of a latex composition and use of the gelling agent of the invention are indicated in the appended claims.

Other features, details and advantages of the invention will become apparent from the description given hereafter as non-limiting with reference to the appended Fig.s.

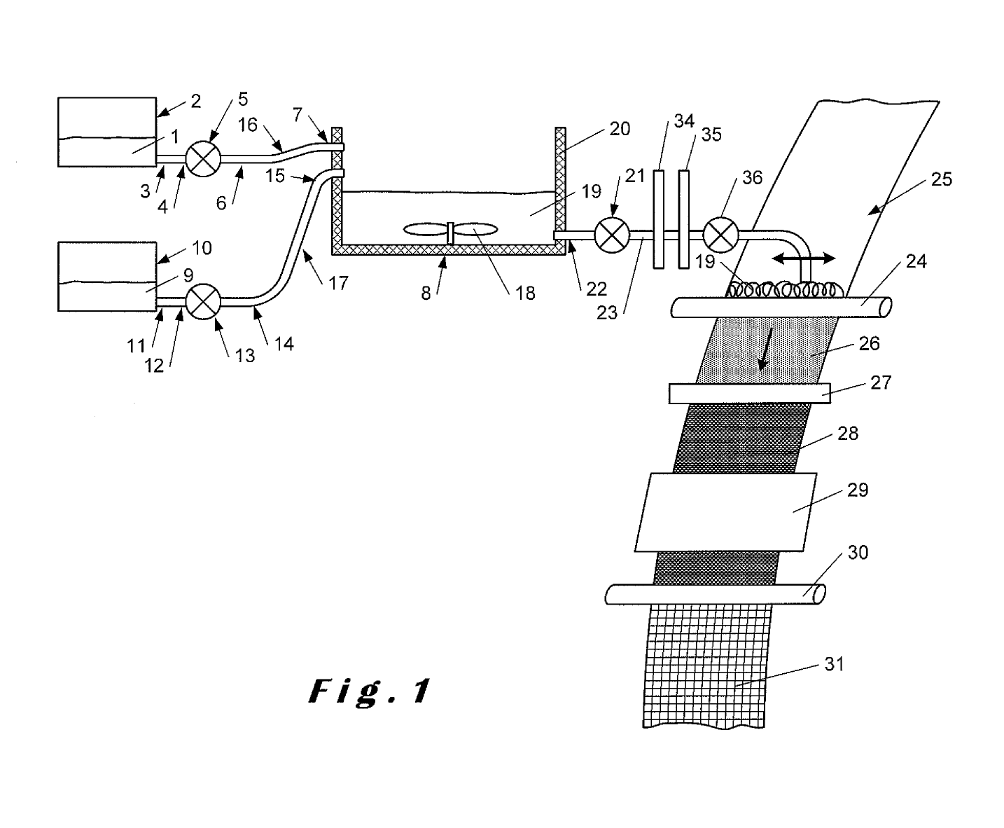

FIG. 1 is an illustration of one embodiment of a method for manufacturing carpet backings according to the invention.

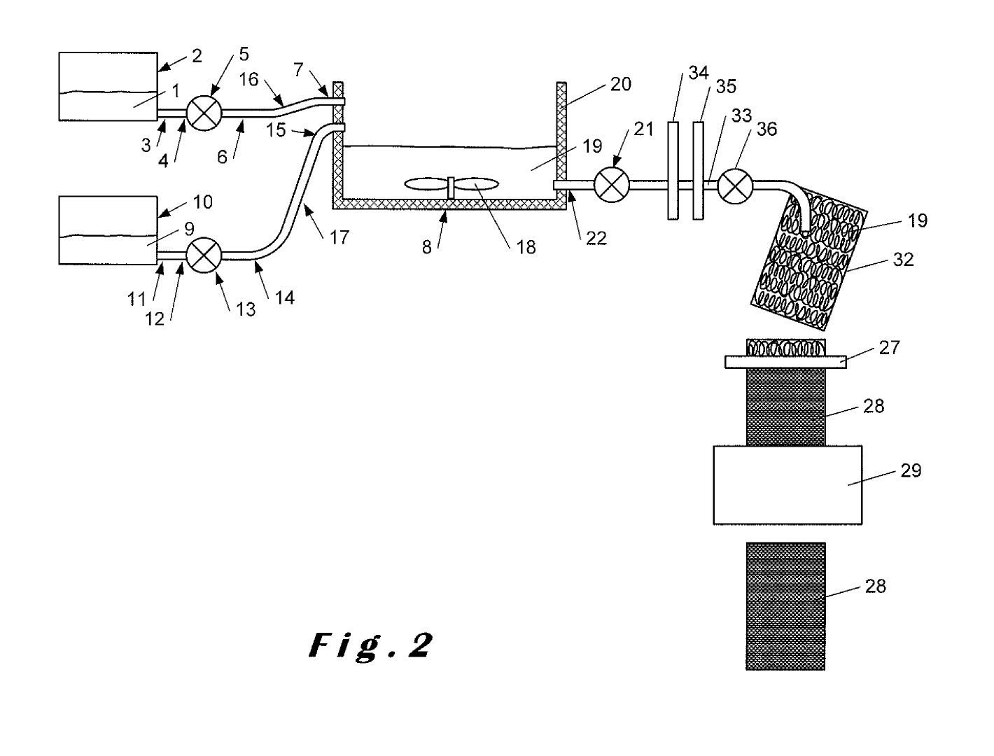

FIG. 2 is an illustration of one embodiment of a method for manufacturing mattresses according to the invention.

In the Figs, identical or similar elements have the same references.

According to one embodiment of the invention, a latex composition having a density of less than 450 g/l in the foamed and gelled state, comprising a gelling agent selected from the group of polyether-polysiloxanes, zinc oxide as a vulcanizing agent, an ethoxylated fatty acid as a non-ionic foaming agent and a styrene-butadiene latex compound containing less than 55% styrene, is obtained by the supply of each product in a mixing vessel where they are mixed to obtain a stable, foamable, gellable and homogeneous latex composition. Each of these components must first be metered accurately so that the latex composition obtained after the mixture is stable and has the expected characteristics including a density of less than 450 g/l in the foamed and gelled state.

According to another embodiment of the invention, a latex composition having a density of less than 450 g/l in the foamed and gelled state is obtained by mixing in a mixing vessel, a first pre-mixture on the one hand comprising a polyether-polysiloxane as a gelling agent and zinc oxide as a vulcanizing agent with a carboxylated styrene-butadiene latex compound (SBR) on the other hand containing less than 55% of styrene and with a C10 polyethylene glycol ether with 10 ethoxylations (10 EO) used as non-ionic foaming agent. Said latex compound and said non-ionic foaming agent are added separately to the first premix in the mixing vessel or form a second premix when mixed together before being added to the first premix in the mixing vessel.

According to another embodiment of the invention, a latex composition having a density of less than 450 g/l in the foamed and gelled state is obtained by mixing in a mixing vessel, a first pre-mixture on the one hand, comprising a polyether polysiloxane as gelling agent, the zinc oxide as a vulcanizing agent and NEUTRON NI.4 as a non-ionic foaming agent with a carboxylated styrene-butadiene latex compound (SBR), on the other hand, containing less than 55% of styrene. According to this embodiment, the latex compound is added independently in the mixing vessel to the first premix.

According to yet another embodiment according to the invention, a latex composition having a density less than 450 g/l in the foamed gelled state is obtained by mixing in a mixing vessel, on the one hand, a first premix comprising zinc oxide as a vulcanizing agent, a natural rubber latex compound and a carboxylated styrene-butadiene latex (SBR) compound containing less than 55% of styrene with a polyether-polysiloxane used as gelling agent on the other hand, and the C10 polyethylene glycol ether with 10 ethoxylations (10 EO) used as a non-ionic foaming agent. The latter two are either added separately to the first premix in the mixing vessel or form a second premix when mixed together before being added to the first premix in the mixing vessel.

To all latex compositions obtained according to each of the embodiments mentioned above, the following components may be added: a filler is selected from the group consisting of calcium carbonate, magnesium carbonate, silica, titanium dioxide, potassium titanate, glass fibers, talcum, carbon black, feldspar, clays such as kaolin and alkaline alumino-silicate clay, alumina silicate, iron silicate, alumina and magnesia trihydrates, calcium hydroxide and mixtures thereof and/or a thickener is selected from the group consisting of thickeners based on polyacrylate such as polyvinylpyrrolidone, polyvinyl alcohol, polyacrylates and salts thereof, based on polyurethane, cellulose polysaccharide and its derivatives such as carboxymethylcellulose, hydroxyethyl(or methyl)-cellulose, bentonites, natural gums such as those of xanthan, agar, acacia, tragacanth, guar, fumed silica and mixtures thereof.

The use of premixes that combine two products is particularly advantageous since the user is working on initial compositions already metered and homogenized. This is a time saver when producing mixtures of products for said latex composition and gives the possibility of avoiding errors in metering the products.

Moreover, combinations of products to form premixes are made so that the pre-mixed products form stable premixes which may be kept for several months without alteration and/or degradation of the products.

According to a preferred embodiment of a method for manufacturing carpet backings shown in FIG. 1, a latex composition according to the invention is prepared by mixing a latex compound selected from the group of natural latices and synthetic latices and containing less than 55% of styrene with a premix comprising a polyether-polysiloxane as the first product comprising a gelling agent, a zinc oxide as a second product comprising a vulcanizing agent and C10 polyethylene glycol ether with 10 ethoxylations (10 EO) as a third product comprising a non-ionic foaming agent.

On the one hand, said latex compound (1) is initially contained in a reservoir (2) provided with an outlet (3) connected to the inlet (4) of a pump (5) whose outlet (6) is connected to an inlet (7) of a mixing vessel (8). On the other hand, said premix (9) is contained in another container (10) also provided with an outlet (11) connected to the inlet (12) of a pump (13) whose outlet (14) is connected to an inlet (15) of the mixing vessel (8). The pump (5) and the pump (13) are respectively activated to bring said latex compound (1) and said premix (9) into said mixing vessel (8), respectively through the feed pipes (16, 17) connected to the inlets (7, 15) of said mixing vessel (8). In said mixing vessel (8), said latex compound (1) and said premix (9) are mixed with a device (18) laid out in order to homogenize the mixture. During this mixing step, there is formation of a homogeneous latex composition (19).

Said vessel (8) is optionally provided with a cooling system (20) for cooling the composition (19) to which energy is incorporated during mixing in order to avoid pre-gelation of said composition (19) subjected to an elevated temperature by accumulation of energy.

Once the homogeneous latex composition (19) is obtained, a pump (21) connected to an outlet (22) of said mixing vessel (8) ensures the suction of said composition (19) which is brought to two foaming machines (34, 35) placed in series where foaming takes place so that the latex composition (19) has a density of less than 450 g/l.

Then, the latex composition (19) having a density of less than 450 g/l is supplied, via a pump (36) and a pipe (23) performing reciprocal movements back and forth (indicated by double arrow), before a scraper (fixed roll) (24) under which runs a face opposite to an apparent face side of a carpet (25) (direction indicated by the arrow). Positioning said roll (24), maintained at a predetermined height relative to the surface of said one face opposite to an apparent face of a carpet (25), allows homogeneous spreading of said foamed and gellable latex composition (19) which will thus be spread as a regular and homogeneous layer (26) on said one face opposite to an apparent face of a carpet (25) passing under said roller (24).

Said one face opposite to an apparent face of a carpet (25) thus covered by a regular and homogeneous layer (26) of said foamed and gellable latex composition (19) will then pass under an infrared device (27) which is laid out for ensuring gelling of said foamed and gellable latex composition (19) covering said one face opposite to an apparent face of a carpet (25). Following this initial gelling step, said one face opposite to an apparent face of a carpet (25) comprising a gelled latex composition (28) on its surface is brought into a gelation steamer (or gelling oven) (28) where a second gelling step occurs by partial dehydration of the gelled layer of latex (28) present on said one face opposite to an apparent face of a carpet (25).

Following this second gelling step, said one face opposite to an apparent face of a carpet (25) is carried away to a stamper (30) laid out for printing, by rotation about an axis, patterns (31) in the gelled layer of latex.

FIG. 2 illustrates a method for manufacturing mattresses of the invention. The steps in this process are identical with those described for obtaining carpet backings up to the foaming step occurring in the foaming machines (34, 35) in series. Following the foaming, the latex composition (19) has a density of less than 450 g/l. This latex composition (19) having a density of less than 450 g/l is fed into a mold (32) via a pipe (33) and a pump (36). The mold (32), when filled with said foamed and gellable latex composition up to a predetermined height, is carried away to an infrared device (27) which is laid out for ensuring gelling of said foamed and gellable latex composition (19). Following this first gelling step, said mold (32) comprising a gelled latex composition (28) is brought into a steamer (or gelling oven) (29) where a second step of gelation occurs by partial dehydration of the gelled latex layer (28) present in said mold (32). Once gelation is completed, the obtained mattresses are taken out of said mold (32) (mold removal step).

### EXAMPLES

### Example 1

### Latex Compositions According to the Invention

A first latex composition (parts by dry weight) was prepared using the following formulation shown in Table 1.

TABLE 1
Composition No. 1 of the invention

| Compounds | ppc | Description |
|---|---|---|
| NR Latex LA | 30 | Natural latex (low ammonia) |
| xSBR - XZ | 70 | Carboxylated styrene-butadiene latex |
| 92227.01 | | (styrene = 51-52%) |
| Gelling agent | 0.6 | Gelling agent: polyether polysiloxane |
| TPA 4380 | | from momentive |
| Neutron NI.5 | 1.5 | Non-ionic foaming agent: Mix of: C10 |
| | | polyethylene glycol alkylether (10EO): |
| | | Lutensol ® XL.100; Cocodimethylaminoxide: |
| | | Genaminox ® CSL; aromatic polyglycol |
| | | ether: Emulvin ® W; Alkyl dihydroxyethyl |
| | | amine oxide: Genaminox ® CHE; alkoxylated |
| | | fatty alcohol: Genapol ® 2822 |
| Zinc oxide | 1.6 | Vulcanizing agent |
| MBT | 0.5 | Accelerator |
| ZDBC | 1 | Accelerator |
| Sulfur | 2 | Vulcanizing agent |
| calcium carbonate | 170 | Filler |
| 80 μm | | |
| Methocel ™ 228 | 0.1 | Thickener: modified hydroxypropylmethyl |
| | | cellulose |

The natural latex is a natural polyisoprene latex and SBR latex is a carboxylated latex containing 52% styrene.

A second latex composition (parts by dry weight) was prepared using the following formulation shown in Table 2.

TABLE 2
Composition No. 2 of the invention

| Components | ppc | Description |
|---|---|---|
| xSBR - XZ | 100 | Carboxylated styrene-butadiene latex |
| 92227.01 | | (styrene = 51-52%) |
| Tego ® | 0.5 | Gelling agent: polysiloxane polyether |
| Coagulant | | Evonik ® |
| 4720 | | |
| Neutron NI.4 | 2 | Non-ionic foaming agent: Mix of: C10 |
| | | polyethylene glycol alkylether (10EO): |
| | | Lutensol ® XL.100; Cocodimethyl- |
| | | aminoxide: Genaminox ® CSL; aromatic |
| | | polyglycol ether: Emulvin ® W; Alkyl- |
| | | dihydroxyethyl amine oxide: |
| | | Genaminox ® CHE; alkoxylated fatty |
| | | alcohol: Genapol ® 2822 |
| Zinc oxide | 1 | Vulcanizing agent |
| MBT | 0.4 | Accelerator |
| ZDBC | 0.8 | Accelerator |
| Calcium carbonate | 170 | Filler |
| 80 μm | | |
| Methocel ™ 228 | 0.07 | Thickener: modified hydroxypropylmethyl |
| | | cellulose |

The SBR latex is a carboxylated latex containing 52% styrene.

A third latex composition (parts by dry weight) was prepared using the following formulation shown in Table 3.

TABLE 3
Composition No. 3 of the invention

| Compounds | ppc | Description |
|---|---|---|
| xSBR - XZ | 100 | Carboxylated styrene-butadiene latex |
| 92227.01 | | (styrene = 51-52%) |
| Tego ® | 0.5 | Gelling agent: polysiloxane polyether |
| Coagulant | | Evonik ® |
| 4720 | | |
| Neutron NI.6 | 1.9 | Non-ionic foaming agent: Mix of: C10 |
| | | polyethylene glycol alkylether (10EO): |
| | | Lutensol ® XL.100; Cocodimethyl- |
| | | aminoxide: Genaminox ® CSL; aromatic |
| | | polyglycol ether: Emulvin ® W; Alkyl- |
| | | dihydroxyethyl amine oxide: |
| | | Genaminox ® CHE; alkoxylated fatty |
| | | alcohol: Genapol ® 2822 |
| Zinc oxide | 1.6 | VULCANIZING AGENT |
| calcium | 170 | FILLER |
| carbonate | | |
| 80 μm | | |
| Methocel ™ 228 | 0.07 | Thickener: modified hydroxypropylmethyl |
| | | cellulose |

The SBR latex is a carboxylated latex containing 52% styrene.

### Example 2

### Comparative Examples

The three compositions comprising a non-ionic foaming agent obtained according to the invention described above were compared in terms of gelling compositions comprising ionic foaming agents and the compositions of which are set out below in Tables 4 to 11.

TABLE 4
Composition No. 4

| COMPONENTS | PPC | DESCRIPTION |
|---|---|---|
| xSBR - XZ | 100 | Carboxylated styrene-butadiene latex |
| 92227.01 | | (styrene = 51-52%) |
| TEGO ® | 0.5 | GELLING AGENT: POLYSILOXANE |
| COAGULANT 4720 | | POLYETHER EVONIK ® |
| POTASSIUM | 1.5 | ANIONIC FOAMING AGENT: |
| OLEATE | | POTASSIUM SALT OF OLEIN |
| ZINC OXIDE | 1.6 | VULCANIZING AGENT |
| CALCIUM | 170 | FILLER |
| CARBONATE 80 μm | | |
| METHOCEL ™ 228 | 0.1 | Thickener: modified hydroxypropylmethyl |
| | | cellulose |

TABLE 5
Composition No. 5

| COMPONENTS | PPC | DESCRIPTION |
|---|---|---|
| xSBR - XZ | 100 | Carboxylated styrene-butadiene latex |
| 92227.01 | | (styrene = 51-52%) |
| TEGO ® | 0.5 | GELLING AGENT: POLYSILOXANE |
| COAGULANT 4720 | | POLYETHER EVONIK ® |
| SODIUM LAURYL | 1.5 | ANIONIC FOAMING AGENT |
| ETHER SULFATE | | |
| ZINC OXIDE | 1.6 | VULCANIZING AGENT |
| CALCIUM | 170 | FILLER |
| CARBONATE 80 μm | | |
| METHOCEL ™ 228 | 0.1 | Thickener: modified hydroxypropylmethyl |
| | | cellulose |

TABLE 6
Composition No. 6

| COMPONENTS | PPC | DESCRIPTION |
|---|---|---|
| xSBR - XZ | 100 | Carboxylated styrene-butadiene latex |
| 92227.01 | | (styrene = 51-52%) |
| TEGO ® | 0.2 | GELLING AGENT: POLYSILOXANE |
| COAGULANT 4720 | | POLYETHER EVONIK ® |
| SODIUM | 1.5 | ANIONIC FOAMING AGENT |
| LAURYLSULFATE | | |
| ZINC OXIDE | 1.6 | VULCANIZING AGENT |
| CARBONATE OF | 170 | FILLER |
| CALCIUM 80 μm | | |
| METHOCEL ™ 228 | 0.1 | Thickener: modified hydroxypropylmethyl |
| | | cellulose |

TABLE 7
Composition No. 7

| COMPONENTS | PPC | DESCRIPTION |
|---|---|---|
| xSBR - XZ | 100 | Carboxylated styrene-butadiene latex |
| 92227.01 | | (styrene = 51-52%) |
| TEGO ® | 0.5 | GELLING AGENT: POLYSILOXANE |
| COAGULANT 4720 | | POLYETHER EVONIK ® |
| HOSTAPUR OS | 1.5 | ANIONIC FOAMING AGENT: C14-C16 |
| | | ALPHA OLEFIN SULFONATE |
| ZINC OXIDE | 1.6 | VULCANIZING AGENT |
| CALCIUM | 170 | FILLER |
| CARBONATE 80 μm | | |
| METHOCEL ™ 228 | 0.1 | Thickener: modified hydroxypropylmethyl |
| | | cellulose |

TABLE 8
Composition No. 8

| COMPONENTS | PPC | DESCRIPTION |
|---|---|---|
| xSBR - XZ | 100 | Carboxylated styrene-butadiene latex |
| 92227.01 | | (styrene = 51-52%) |
| TEGO ® | 0.5 | GELLING AGENT: POLYSILOXANE |
| COAGULANT 4720 | | POLYETHER EVONIK ® |
| SODIUM | 1.3 | ANIONIC FOAMING AGENT |
| DIETHYLHEXYL | | |
| SUCCINATE | | |
| ZINC OXIDE | 1.6 | VULCANIZING AGENT |
| CALCIUM | 170 | FILLER |
| CARBONATE 80 μm | | |
| METHOCEL ™ 228 | 0.1 | Thickener: modified hydroxypropylmethyl |
| | | cellulose |

TABLE 9
Composition No. 9

| COMPONENTS | PPC | DESCRIPTION |
|---|---|---|
| xSBR - XZ | 100 | Carboxylated styrene-butadiene latex |
| 92227.01 | | (styrene = 51-52%) |
| TEGO ® | 0.5 | GELLING AGENT: POLYSILOXANE |
| COAGULANT 4720 | | POLYETHER EVONIK ® |
| TALLOW | 1.4 | ANIONIC FOAMING AGENT |
| ZINC OXIDE | 1.6 | VULCANIZING AGENT |
| CALCIUM | 170 | FILLER |
| CARBONATE 80 μm | | |
| METHOCEL ™ 228 | 0.25 | Thickener: modified hydroxypropyl- |
| | | methyl cellulose |

TABLE 10
Composition No. 10

| COMPONENTS | PPC | DESCRIPTION |
|---|---|---|
| xSBR - XZ | 100 | Carboxylated styrene-butadiene latex |
| 92227.01 | | (styrene = 51-52%) |
| TEGO ® | 0.5 | GELLING AGENT: POLYSILOXANE |
| COAGULANT 4720 | | POLYETHER EVONIK ® |
| POTASSIUM | 1.5 | Anionic foaming agent: Potassium salt |
| RICINOLEATE | | of castor oil |
| ZINC OXIDE | 1.6 | VULCANIZING AGENT |
| CALCIUM | 170 | FILLER |
| CARBONATE 80 μm | | |
| METHOCEL ™ 228 | 0.06 | Thickener: modified hydroxypropyl- |
| | | methyl cellulose |

TABLE 11
Composition No. 11

| COMPONENTS | PPC | DESCRIPTION |
|---|---|---|
| xSBR - XZ 92227.01 | 100 | Carboxylated styrene-butadiene latex |
| | | (Styrene = 51-52%) |
| TEGO ® | 0.5 | GELLING AGENT: POLYSILOXANE |
| COAGULANT 4720 | | POLYETHER EVONIK ® |
| DDBS-NA | 1.5 | Anionic foaming agent: sodium |
| (C18H29SO3NA) | | alkylbenzenesulfonate |
| ZINC OXIDE | 1.6 | VULCANIZING AGENT |
| CALCIUM | 170 | FILLER |
| CARBONATE 80 μm | | |
| METHOCEL ™ 228 | 0.17 | Thickener: modified hydroxypropyl- |
| | | methyl cellulose |

All these compositions, listed in Tables 1 to 11, were tested as follow:

application onto a support with a height of 2 mm of an amount between 2 and 7 g of a latex composition according to tables 1 to 11,

heating said latex composition applied on said support by using an infrared lamp with a power of 250 Watts placed at a height of 5 cm relative to the support, for a maximum time of 15 seconds.

At the end of this heating operation, so that the latex composition is considered to be a gelled latex composition as defined in the present invention, the gelation (coagulation) of said latex composition must be total, that is to say that the aforesaid heating operation has to give the possibility of obtaining a non-liquid solid mass of said latex composition. The results of these tests are shown in Table 12.

TABLE 12

| Composition | | | Time |
|---|---|---|---|
| No. | Gelling/coagulation | Solidification | (seconds) |
| 1 | total | / | 9 |
| 2 | total | / | 10 |
| 3 | total | / | 12 |
| 4 | / | by evaporation | 135 |
| 5 | / | by evaporation | 122 |
| 6 | / | by evaporation | 138 |
| 7 | / | by evaporation | 141 |
| 8 | / | by evaporation | 128 |
| 9 | / | by evaporation | 120 |
| 10 | / | by evaporation | 134 |
| 11 | / | by evaporation | 137 |

These results show that only the compositions of the invention comprising a non-ionic foaming agent quickly get an infrared gelation of the composition while the latex compositions comprising ionic foaming agents do not gel but solidify by evaporation and loss of water after a longer time.

It is understood that the present invention is by no way limited to the embodiments described above and that many modifications may be made thereto without departing from the scope of the appended claims.

1. A latex composition comprising:
a) at least one latex compound containing less than 55% of styrene,
b) a heat-sensitive gelling agent selected from the group of polyether-polysiloxanes,
c) a foaming agent, and
d) at least one vulcanizing agent,
characterized in that said foaming agent is a non-ionic foaming agent and in that said latex composition has, in a foamed and gelled state, a density of less than 450 g/l, preferably less than 350 g/l.

2. The composition according to claim 1, characterized in that said latex compound containing less than 55% of styrene is selected from the group consisting of synthetic latices or synthetic latices in a mixture with natural latices.

3. The composition according to claim 1, characterized in that said non-ionic foaming agent is selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof.

4. The composition of claim 1, characterized in that said at least one vulcanizing agent is selected from the group consisting of oxides, mercaptos, sulfenamides, thiurams, thiocarbamates, amines, thiophosphates, thioureas, thiazoles, guanidines, for example zinc bis-dibutyldithiocarbamate (ZDBC), zinc diethyldithiocarbamate (ZDEC), zinc dimethyldithiocarbamate (ZDMC), zinc or sodium 2-mercaptobenzothiazole (MBT or NaMBT), 2,2′-dithiobenzothiazole disulfide (MBTS), N-cyclohexylbenzothiazole 2-sulfenamide (CBS), N-tert-butylbenzothiazole 2-sulfenamide (TBBS), bis-(triethoxysilylpropyl)tetrasulfide (TESPT), tetraethylthiuram disulfide, tetramethylthiuram disulfide (TMTD), tetramethylthiuram monosulfide (TMTM), tetramethylthiuram polysulfide (TMTP), dipentamethylene thiuram hexasulfide (DPTH), dimethyldithiocarbamate (DMTC), N,N′-ethylene thiourea (ETU), 2-(morpholinothio)benzothiazole (MBS), sulfur (S), N,N′-diphenylguanidine, N,N′-di-o-tolylguanidine, oxides of magnesium (MgO), zinc (ZnO), calcium (CaO), barium (BaO), copper (CuO), cerium (CeO), stearic acid (SA), zinc stearate, zinc 2-ethylhexanoate (ZEH), zinc monoglycerolate (Zn-m-glyc), zinc sulfide (ZnS), dibutylamine (DBA), diphenylguanidine (DPG), and mixtures thereof.

5. The composition of claim 1, characterized in that it further comprises a filler, said filler being selected from the group consisting of calcium carbonate, magnesium carbonate, silica, titanium dioxide, potassium titanate, glass fibers, talcum, carbon black, feldspar, clays such as kaolin and alkaline aluminosilicate clay, alumina silicate, iron silicate, alumina and magnesia trihydrates, calcium hydroxide and mixtures thereof.

6. The composition of claim 1, characterized in that it further comprises a thickener, said thickener being selected from the group consisting of thickeners based on polyacrylate such as polyvinylpyrrolidone, polyvinyl alcohol, polyacrylates and their salts, on polyurethane, polysaccharide cellulose and its derivatives such as carboxymethylcellulose, hydroxyethyl(or methyl)cellulose, bentonites, natural gums such as those of xanthan, agar, acacia, guar gum, fumed silica and mixtures thereof.

7. Products such as combined compositions for simultaneous, separate use or staggered in time to prepare a foamed and gelled latex having a density of less than 450 g/l, comprising:
a) a first product comprising a gelling agent selected from the group of polyether-polysiloxanes,
b) a second product comprising a vulcanizing agent selected from the group consisting of oxides, mercaptos, sulfenamides, thiurams, thiocarbamates, amines, thiophosphates, thioureas, thiazoles, guanidines, for example zinc bis-dibutyldithiocarbamate (ZDBC), zinc diethyldithiocarbamate (ZDEC), zinc dimethyldithiocarbamate (ZDMC), zinc or sodium 2-mercaptobenzothiazole (MBT or NaMBT), 2,2′-dithiobenzothiazole disulfide (MBTS), N-cyclohexylbenzothiazole 2-sulfenamide (CBS), N-tert-butylbenzothiazole 2-sulfenamide (TBBS), bis-(triethoxysilylpropyl)tetrasulfide (TESPT), tetraethylthiuram disulfide, tetramethylthiuram disulfide (TMTD), tetramethylthiuram monosulfide (TMTM), tetramethylthiuram polysulfide (TMTP), dipentamethylene thiuram hexasulfide (DPTH), dimethyldithiocarbamate (DMTC), N,N′-ethylene thiourea (ETU), 2-(morpholinothio)benzothiazole (MBS), sulfur (S), N,N′-diphenylguanidine, N,N′-di-o-tolylguanidine, oxides of magnesium (MgO), zinc (ZnO), calcium (CaO), barium (BaO), copper (CuO), cerium (CeO), stearic acid (SA), zinc stearate, zinc 2-ethylhexanoate (ZEH), zinc monoglycerolate (Zn-m-glyc), zinc sulfide (ZnS), dibutylamine (DBA), diphenylguanidine (DPG), and mixtures thereof.
c) a third product comprising a non-ionic foaming agent selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugars esters, condensed alkanolamides, amine oxides, polyethyleneglycols, ethoxylated or non-ethoxylated sorbitan esters, ethoxylated/propoxylated copolymers and mixtures thereof.
d) a fourth product comprising a latex compound selected from the group of natural latices and synthetic latices and mixtures thereof.

8. Products such as combined compositions according to claim 7 as premixes of said combined compositions, said premixes comprising said first and second products and/or said first, second and third products and/or said third and fourth products or said second and fourth products.

9. A method of making a latex composition comprising the following steps:
a) supplying a latex compound selected from the group of natural latices and synthetic latices and mixtures thereof into a mixing vessel,
b) supplying a vulcanizing agent selected from the group of vulcanizing agents consisting of oxides, mercaptos, sulfenamides, thiurams, thiocarbamates, amines, thiophosphates, thioureas, thiazoles, guanidines, for example zinc bis-dibutyldithiocarbamate (ZDBC), zinc diethyldithiocarbamate (ZDEC), zinc dimethyldithiocarbamate (ZDMC), zinc or sodium 2-mercaptobenzothiazole (MBT or NaMBT), 2,2′-dithiobenzothiazole disulfide (MBTS), N-cyclohexylbenzothiazole 2-sulfenamide (CBS), N-tert-butylbenzothiazole 2-sulfenamide (TBBS), bis-(triethoxysilylpropyl)tetrasulfide (TESPT), tetraethylthiuram disulfide, tetramethylthiuram disulfide (TMTD), tetramethylthiuram monosulfide (TMTM), tetramethylthiuram polysulfide (TMTP), dipentamethylene thiuram hexasulfide (DPTH), dimethyldithiocarbamate (DMTC), N,N′-ethylene thiourea (ETU), 2-(morpholinothio)benzothiazole (MBS), sulfur (S), N,N′-diphenylguanidine, N,N′-di-o-tolylguanidine, oxides of magnesium (MgO), zinc (ZnO), calcium (CaO), barium (BaO), copper (CuO), cerium (CeO), stearic acid (SA), zinc stearate, zinc 2-ethylhexanoate (ZEH), zinc monoglycerolate (Zn-m-glyc), zinc sulfide (ZnS), dibutylamine (DBA), diphenylguanidine (DPG), and mixtures thereof,
c) adding a vulcanizing agent in said mixing vessel,
d) supplying a non-ionic foaming agent selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof,
e) adding said non-ionic foaming agent in said mixing vessel to form a foamed and gellable latex,
f) supplying a gelling agent selected from the group of polyether-polysiloxanes,
g) adding said gelling agent in said mixing vessel,
h) supplying and adding a filler selected from the group of fillers consisting of calcium carbonate, magnesium carbonate, silica, titanium dioxide, potassium titanate, glass fibers, talcum, carbon black, feldspar, clays such as kaolin and alkaline alumino-silicate clay, alumina silicate, iron silicate, alumina and magnesia trihydrates, calcium hydroxide and mixtures thereof,
i) supplying and adding a thickener selected from the group consisting of thickeners based on polyacrylate such as polyvinylpyrrolidone, polyvinyl alcohol, polyacrylates and their salts, on polyurethane, polysaccharide cellulose and its derivatives such as carboxymethylcellulose, hydroxyethyl(or methyl)cellulose, bentonites, natural gums such as those of xanthan, agar, acacia, guar gum, fumed silica and mixtures thereof.
j) applying said foamed gellable latex on a support or into a mold,
k) gelling said gellable foamed latex applied to a substrate or in a mold.

10. A manufacturing method according to claim 9, characterized in that said addition of non-ionic foaming agent is carried out in said vessel containing said latex compound.

11. A manufacturing method according to claim 9, characterized in that said addition of non-ionic foaming agent is carried out in said supply of said gelling agent.

12. A manufacturing method according to claim 9, characterized in that said addition of the vulcanizing agent is carried out in said vessel containing said compound latex.

13. A manufacturing method according to claim 9, characterized in that said addition of the vulcanizing agent is carried out in said supply of said gelling agent.

14. A manufacturing method according to claim 9, characterized in that said application of said foamed gellable latex is performed on a face opposite to a visible face of a carpet.

15. A manufacturing method according to claim 9, characterized in that said gelling of said foamed gellable latex applied to a substrate or in a mold is performed by applying rays characterized by a wavelength in the infrared range.

16. A manufacturing method according to claim 9, characterized in that it further comprises a step for embossing a pattern on said foamed and gelled latex.

17. The use of the composition of latex according to claim 1 for the manufacture of preferably uniform carpet backings, and mattresses.

18. The use of a foaming non-ionic agent selected from the group of non-ionic foaming agents consisting of polyglycolated or sulfated fatty alcohol ethers, ethoxylated castor oils, ethoxylated fatty amines, ethoxylated fatty acids, glycerol esters, glycol esters, polyoxyethyleneglycol esters, polyoxyethylene sorbitan esters, sugar esters, condensed alkanolamides, amine oxides, polyethyleneglycols, ethoxylated or non-ethoxylated sorbitan esters, ethoxylated/propoxylated copolymers and mixtures thereof, for gelation of latex compositions having a density of less than 450 g/l, preferably less than 350 g/l, in the foamed and gelled state.

19. Use of a foaming agent non-ionic according to claim 18, for the manufacture of carpet backings and mattresses.
